(19) United States
(12) Patent Application Publication
(10) Pub. No.: US 2019/0353332 A1
(43) Pub. Date: Nov. 21, 2019

(54) Multi-Function Work Light

(71) Applicant: E. MISHAN & SONS, INC., New York, NY (US)

(72) Inventor: Changxian YOU, Ningbo (CN)

(73) Assignee: E. MISHAN & SONS, INC., NEW YORK, NY (US)

(21) Appl. No.: 16/243,346

(22) Filed: Jan. 9, 2019

(30) Foreign Application Priority Data
May 21, 2018 (CN) ZL 2018 3 0234713

(51) Int. Cl. F21V 17/10; F21V 15/01; F21L 4/02; F21V 23/04

(52) U.S. Cl. CPC F21V 17/107; F21V 15/01; F21Y 2115/10; F21V 23/0414; F21L 4/02

(57) ABSTRACT

A work light has two housings with an elongated LED array in each housings, a hinge arrangement pivotally connecting the housings to each other for movement between a deployed position with front surfaces in the same plane for casting all light substantially in one direction, and a compact position with a rear surfaces against each other, for casing light in opposite directions, the hinge arrangement allowing intermediate angled positions for casting light in different directions, and a pair of legs pivotally connected to the hinge arrangement for rotation between an extended position with the legs on opposite sides of the hinge arrangement and a storage position with the legs on one side of the hinge arrangement and allowing intermediate angled positions between the legs for creating stand positions and allowing free rotation between the housings and the legs to cast light in any selected set of directions.

### FIELD AND BACKGROUND OF THE INVENTION

The present invention relates generally to the field of lighting, and in particular to a new and useful, battery powered work light that has multiple positions and orientations for casting light onto a work or other area.

Work lights in a wide variety of shapes and uses are known. They include plug-in, historically incandescent, so-called drop-lights containing a single screw-in bulb in a cage that shields the fragile glass bulb form damage (hence the name drop-light as it will survive being dropped), an elongated handle and a long power cord. These lights generally case light only in a single direction and have the further drawback of requiring an electrical wall socket for power.

With the advent of highly efficient and powerful, white LEDs, battery powered work lights have become practical. Those have included lights that mimic the shape of the classic drop-light, albeit, without requiring a cord, as well as those that have diverged from the classic shape.

A need remained for a battery powered work light that is versatile and effective in use.

### SUMMARY OF THE INVENTION

It is an object of the present invention to provide a work light that has two housings with an elongated LED array in each housing, a hinge arrangement pivotally connecting the housings to each other for movement between a deployed position with front surfaces in the same plane for casting all light substantially in one direction, and a compact position with the rear surfaces against each other, for casing light in opposite directions, the hinge arrangement allowing intermediate angled positions for casting light in different directions, and a pair of legs pivotally connected to the hinge arrangement for rotation between an extended position with the legs on opposite sides of the hinge arrangement, and a storage position with both legs on one side of the hinge arrangement, and allowing intermediate angled positions between the legs for creating stand positions and allowing free rotation between the housings and the legs to cast light in any selected set of directions.

Another object of the invention is to provide a multi-function work light comprising: a first substantially rectangular housing having front and rear surfaces each defined by a pair of long sides and a pair of connecting short sides, each side having a width defining a volume between the front and rear surfaces; a second substantially rectangular housing having front and rear surfaces each defined by a pair of long sides and a pair of connecting short sides, each side having a width defining a volume between the front and rear surfaces; an elongated LED array in each volume of the first and second housings each LED array having a light emitting surface near the front surface of each of the first and second housings respectively; a hinge arrangement pivotally connecting the first and second housings to each other along one of their respective long sides, for movement from a deployed position with the front surfaces of the first and second housings being in the same plane for casting all light substantially in one direction, to a compact position with the rear surfaces of the first and second housings being parallel and adjacent each other, for casing light outwardly in opposite directions, the hinge arrangement allowing a plurality of intermediate angled positions between the first and second housings between the deployed and compact positions, for casting light from the first and second housings in different directions at the same time; and a pair of legs pivotally connected to at least one end of the hinge arrangement for rotation of the legs between an extended position with the legs on opposite sides of the hinge arrangement, and a storage position with the legs on one side of the hinge arrangement, the hinge arrangement allowing a plurality of intermediate angled positions between the legs for creating stand positions for supporting the first and second housings above a support surface, the hinge arrangement also allowing free relative rotation between the housings and the legs to allow light to be cast toward any selected set of directions, depending on the position of the housings and the legs.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of a work light embodying the invention in one possible position for use;

FIG. 2 is a perspective view of the work light if FIG. 1 in another possible position for use;

FIG. 3 is a is a perspective view of the work light of FIG. 1 in a possible use, carry, hang or storage position;

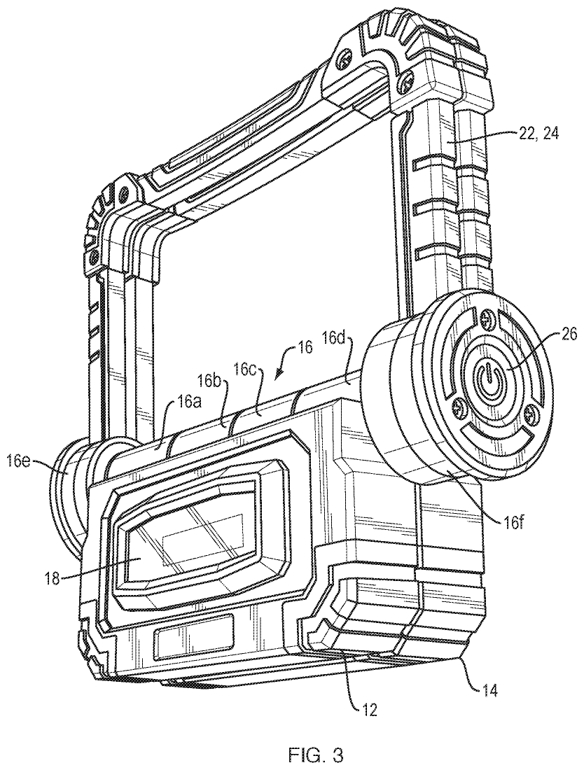

FIG. 4 is a perspective view of the work light of FIG. 1 in another compact position, primarily, but not exclusively for storage; and

FIG. 5 is a is a perspective view of the work light of FIG. 1 in a further possible use, carry, hang or storage position.

### DESCRIPTION OF THE PREFERRED EMBODIMENTS

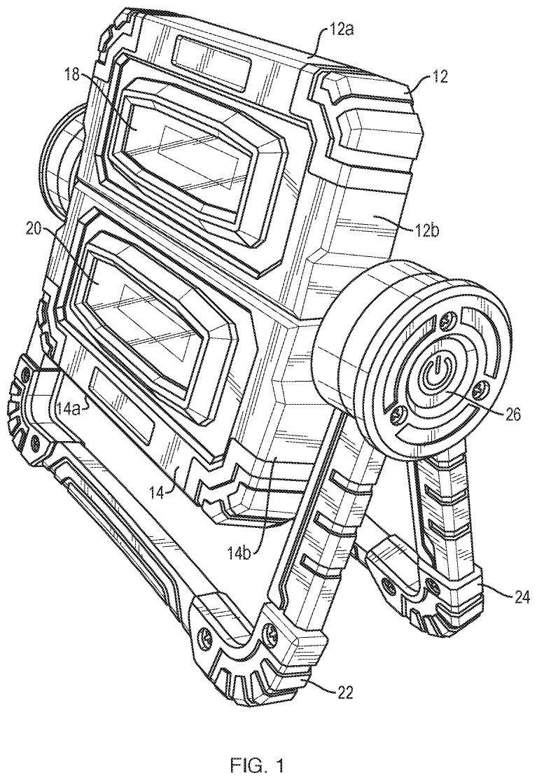

Referring now to the drawings, in which like reference numerals are used to refer to the same or similar elements, FIG. 1 shows a multi-function work light 10 comprising a first substantially rectangular housing 12 having front and rear surfaces each defined by a pair of long sides 12a and a pair of connecting short sides 12b, each side having a width defining a volume between the front and rear surfaces.

The work light also includes a second substantially rectangular housing 14, also having front and rear surfaces each defined by a pair of long sides 14a and a pair of connecting short sides 14b, each side having a width defining a volume between the front and rear surfaces of this housing as well.

Elongated, high intensity, battery powered, LED arrays 18 and 20, each made up of multiple columns and rows of individual white LEDs, is fixed in each housing volume, each LED array having a light emitting surface near the front surface of each of the first and second housings respectively. Each LED array may include only one LED or a single row of LEDs.

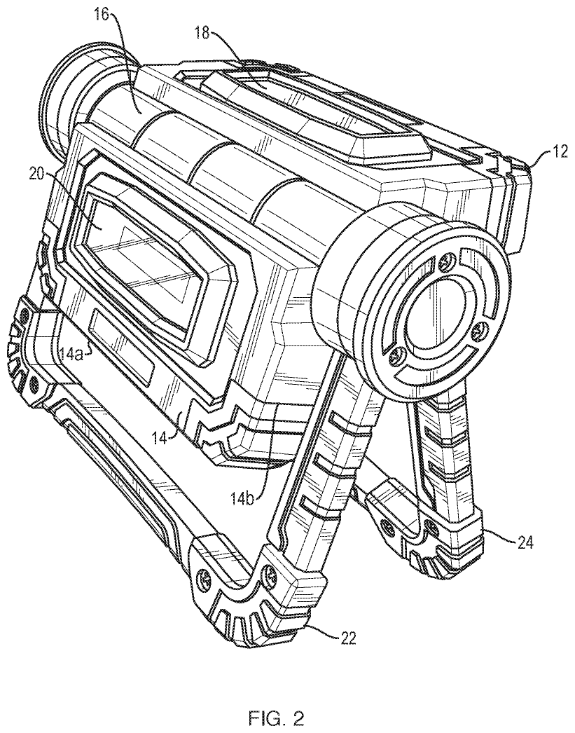

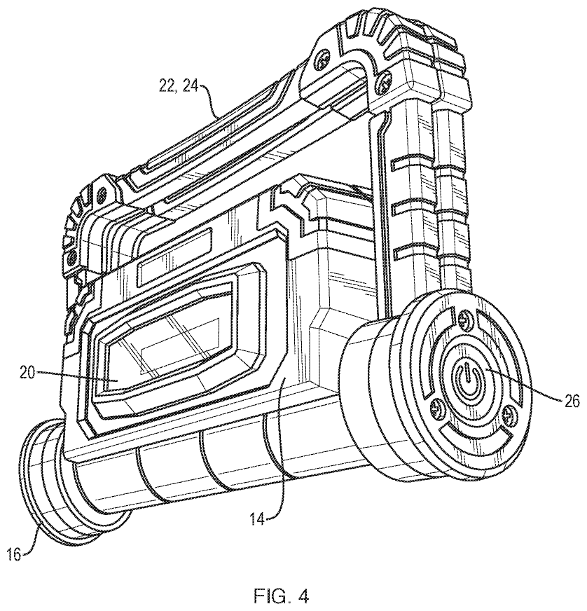

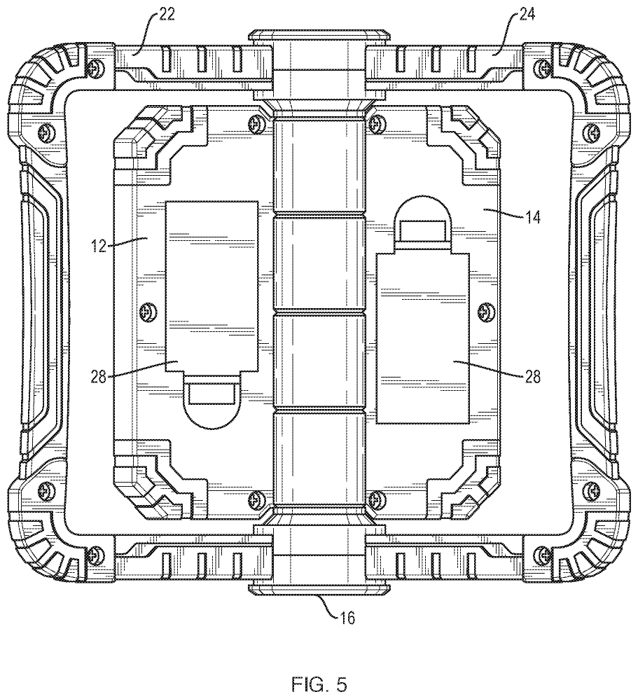

A hinge arrangement 16 pivotally connects the first and second housings 12 and 14 to each other along one of their respective long sides 12a and 14a, for movement from a deployed position shown in FIGS. 1 and 5, with the front surfaces of the first and second housings being in the same plane for casting all light substantially in one direction, to a compact position shown in FIG. 4, with the rear surfaces of the first and second housings being parallel to and adjacent each other, for casing light outwardly in opposite directions. The hinge arrangement 16 allows any number of intermediate angled positions between the first and second housings, between the deployed and compact positions, for casting light from the first and second housings in different directions at the same time. One such intermediate position is shown in FIG. 2.

A pair of preferably but not exclusively U-shaped legs 22 and 24 are pivotally connected to the opposite ends of the hinge arrangement 16, for rotation of the legs between an extended position shown in FIG. 5, with the legs on opposite sides of the hinge arrangement 16, and a storage position shown in FIG. 4, with the legs on one side of the hinge arrangement 16. The hinge arrangement 16 allows many intermediate angled positions between the legs for creating different stand positions, one being shown in FIGS. 1 and 2 for supporting the first and second housings 12, 14 above a support surface. The hinge arrangement 16 also allows free relative rotation between the housings 12, 14 and the legs 22, 24, to allow light to be cast toward any selected set of directions, depending on the position of the housings and the legs.

As mentioned each leg 22 and 24 is preferably U-shaped and has opposite ends pivotally connected to each respective end of the hinge arrangement 16, and to each other. However, other shaped legs may by used, such as L-shaped legs where each leg is connected to the hinge arrangement at only one end. In any case, the legs must defining a space between their ends of receiving the housings as shown in FIGS. 4 and 5, and for allowing free rotation between the housings and the legs. Free rotation between the two housings 12 and 14, and free rotation between the two legs 22 and 24, as well as free rotation between the housings and legs, allows the work light to be oriented into hundreds of positions to illuminate any work or other area and various ways.

At least one battery is provided in a suitable battery holder of known or to be created design, in each housing volume and is electrically connected to each respective LED array. A suitable circuit with preferably, but not exclusively pushbutton switch 26 is wired to the battery and LED array for powering the LEDs when the switch is activated, e.g. by pressing it once. A battery access door 28 in each rear surface of a respective housing closes the battery or batteries in their respective housing. Switch 26 is preferably at one end of the hinge arrangement 16.

The circuit may include means for lighting one, the other, or both LED arrays, based on the number of presses on the pushbutton switch 26. For example, both LED arrays 18 and 20 may be powered to light all LEDs upon a first pressing of switch 26. A second pressing of the switch may extinguish one of the LED arrays, leaving the other “on” with a third pressing extinguishing the previously lit LED, and lighting the other. A fourth pressing of the pushbutton switch 26 may then extinguish both LED arrays to the “off” state.

Any different pressing sequence may be used as well and other modes of operation may be included like a flashing mode, a mode where the two LED arrays alternately flash, a dimming mode for more subdued light, and other modes of operation.

In any case, the capacity to light one or the other LED array, and the work light's many different illumination positions make this work light extremely versatile to use and store.

The hinge arrangement 16 includes a plurality of hinge hoops 16a, 16b, 16c, 16d, 16e and 16f, that are rotatable about a common axis, at least two of the hoops being connected to the first housing 12 and at least two others of the hoops being connected to the second housing 14.

Two pairs of hoops 16e and 16f at the opposite ends of the hinge arrangement 16, are connected to respective leg ends to achieve the various rotation combination of legs 22 ans 24 and housings 12 and 14 that are possible.

While a specific embodiment of the invention has been shown and described in detail to illustrate the application of the principles of the invention, it will be understood that the invention may be embodied otherwise without departing from such principles.

What is claimed is:

1. A multi-function work light (10) comprising:
a first substantially rectangular housing (12) having front and rear surfaces each defined by a pair of long sides (12a) and a pair of connecting short sides (12b), each side having a width defining a volume between the front and rear surfaces;
a second substantially rectangular housing (14) having front and rear surfaces each defined by a pair of long sides (14a) and a pair of connecting short sides (14b), each side having a width defining a volume between the front and rear surfaces;
an LED array (18, 20) in each volume of the first and second housings (12, 14) each LED array having a light emitting surface near the front surface of each of the first and second housings respectively;
a hinge arrangement (16) pivotally connecting the first and second housings (12, 14) to each other along one of their respective long sides, for movement from a deployed position with the front surfaces of the first and second housings being in the same plane for casting light substantially in one direction, to a compact position with the rear surfaces of the first and second housings being parallel and adjacent each other, for casing light outwardly in opposite directions,
the hinge arrangement (16) allowing a plurality of intermediate angled positions between the first and second housings, between the deployed and compact positions, for casting light from the first and second housings in different directions at the same time; and
a pair of legs (22, 24) pivotally connected to at least one end of the hinge arrangement (16) for rotation of the legs between an extended position with the legs on opposite sides of the hinge arrangement, and a storage position with the legs on one side of the hinge arrangement, the hinge arrangement allowing a plurality of intermediate angled positions between the legs for creating stand positions for supporting the first and second housings above a support surface, the hinge arrangement also allowing free relative rotation between the housings and the legs to allow light to be cast toward any selected set of directions, depending on the position of the housings and the legs.

2. The multi-function work light of claim 1, wherein each leg is U-shaped and has opposite ends pivotally connected to each respective end of the hinge arrangement, each leg defining a space between its ends of receiving both housings.

3. The multi-function work light of claim 1, including at least battery in each housing volume electrically connected to each respective LED array and a battery access door in each rear surface of a respective housing.

4. The multi-function work light of claim 1, including a switch for powering the LED arrays at one end of the hinge arrangement.

5. The multi-function work light of claim 1, including a pushbutton switch for powering the LED arrays at one end of the hinge arrangement, the switch powering both LED arrays with a pressing of the switch, either one of the LED arrays with a different pressing of the pushbutton switch, and a switching off of both LED arrays with a still different pressing of the pushbutton switch.

6. The multi-function work light of claim 1, wherein the hinge arrangement including a plurality of hinge hoops (16a, 16b, 16c, 16d) rotatable about a common axis, at least two of the hoops being connected to the first housing and at least two others of the hoops being connected to the second housing.

7. The multi-function work light of claim 1, wherein the hinge arrangement including a plurality of hinge hoops (16a, 16b, 16c, 16d, 16e, 16f) rotatable about a common axis, at least two of the hoops being connected to the first housing and at least two others of the hoops being connected to the second housing and at least one further hoop being at the end of the hinge arrangement and being connected to the legs.

8. The multi-function work light of claim 1, wherein each leg is U-shaped and has opposite ends pivotally connected to each respective end of the hinge arrangement, each leg defining a space between its ends of receiving both housings, the hinge arrangement including a plurality of hinge hoops (16a, 16b, 16c, 16d, 16e, 16f) rotatable about a common axis, at least two of the hoops being connected to the first housing and at least two others of the hoops being connected to the second housing and at least two further hoops being at the ends of the hinge arrangement and being connected to the opposite ends of the legs.

9. The multi-function work light of claim 1, wherein each LED array is elongated and includes a plurality of LEDs.

10. A work light comprising: first and second housings each with front and rear surfaces, an LED array in each of the first and second housings, each LED array having a light emitting surface near the front surface of each of the first and second housings respectively, a hinge arrangement pivotally connecting the first and second housings to each other for movement from a deployed position with the front surfaces of the first and second housings being in the same plane for casting all light substantially in one direction, to a compact position with the rear surfaces of the first and second housings parallel and adjacent each other, for casing light outwardly in opposite directions, the hinge arrangement allowing a plurality of intermediate angled positions between the first and second housings, for casting light in different directions at the same time, and a pair of legs pivotally connected to at least one end of the hinge arrangement for rotation between an extended position with the legs on opposite sides of the hinge arrangement and a storage position with the legs on one side of the hinge arrangement, the hinge arrangement allowing a plurality of intermediate angled positions between the legs for creating stand positions for supporting the housings, the hinge arrangement also allowing free rotation between the housings and the legs to allow light to be cast toward any selected set of directions.

11. The work light of claim 10, wherein each leg is U-shaped and has opposite ends pivotally connected to each respective end of the hinge arrangement, each leg defining a space between its ends of receiving both housings.

12. The work light of claim 10, including at least battery in each housing, electrically connected to each respective LED array and a battery access door in each rear surface of a respective housing.

13. The work light of claim 10, including a pushbutton switch for powering the LED arrays at one end of the hinge arrangement, the switch powering both LED arrays with a pressing of the switch, either one of the LED arrays with a different pressing of the pushbutton switch, and a switching off of both LED arrays with a still different pressing of the pushbutton switch.

14. The work light of claim 10, wherein the hinge arrangement including a plurality of hinge hoops rotatable about a common axis, at least two of the hoops being connected to the first housing and at least two others of the hoops being connected to the second housing.

15. The work light of claim 10, wherein each leg is U-shaped and has opposite ends pivotally connected to each respective end of the hinge arrangement, each leg defining a space between its ends of receiving both housings, the hinge arrangement including a plurality of hinge hoops rotatable about a common axis, at least two of the hoops being connected to the first housing and at least two others of the hoops being connected to the second housing and at least two further hoops being at the ends of the hinge arrangement and being connected to the opposite ends of the legs.

16. The multi-function work light of claim 10, wherein each LED array is elongated and includes a plurality of LEDs.
